(19) United States
(12) Patent Application Publication
(10) Pub. No.: US 2026/0110558 A1
(43) Pub. Date: Apr. 23, 2026

(54) DISTRIBUTED OPTIC FIBER SENSOR SYSTEM CAPABLE OF EQUALIZING BACKSCATTERED LIGHT AND METHOD FOR SETTING VARIABLE GAIN OF BACKSCATTERED LIGHT OF OPTIC FIBER SENSOR

(71) Applicant: KOREA INSTITUTE OF GEOSCIENCE AND MINERAL RESOURCES, Daejeon (KR)

(72) Inventors: Sangjin CHOI, Sejong-si (KR); Kwon Gyu PARK, Sejong-si (KR); Byoungjoon YOON, Daejeon (KR); Changhyun LEE, Daejeon (KR)

(21) Appl. No.: 19/361,218

(22) Filed: Oct. 17, 2025

(30) Foreign Application Priority Data
Oct. 18, 2024 (KR) 10-2024-0142611

(51) Int. Cl. G01D 5/353; G01H 9/00

(52) U.S. Cl. CPC G01D 5/35361; G01H 9/004

(57) ABSTRACT

The present disclosure relates to a distributed optic fiber sensor system. The distributed optic fiber sensor system includes a light source configured to transmit light, an optic fiber sensor including an optic fiber through which light transmitted from the light source propagates, an optical amplifier configured to amplify a backscattered light signal scattered and returned from the optic fiber with a constant gain, a semiconductor optical amplifier (SOA) configured to amplify the backscattered light signal amplified by the optical amplifier, but variably amplify the backscattered light signal by increasing a gain as a point where the backscattered light signal is generated in the optic fiber sensor is farther from the light source, an optical detector configured to convert the backscattered light signal amplified by the semiconductor optical amplifier into an electrical signal, and an AD converter configured to convert the electrical signal from the optical detector into a digital signal.

### CROSS-REFERENCE TO RELATED APPLICATION

This application claims priority to Korean Patent Application No. 10-2024-0142611, filed on Oct. 18, 2024, and all the benefits accruing therefrom under 35 U.S.C. § 119, the contents of which are incorporated by reference in their entirety.

### BACKGROUND

The present disclosure relates to a sensor technology for detecting vibration events occurring in ground and structures, and more particularly, to a signal processing technology for backscattered light signals in distributed optic fiber sensors.

FIG. 1 is a diagram for illustrating a distributed optic fiber sensor system.

Referring to FIG. 1, the distributed optic fiber sensor system basically includes a light source, an optic fiber, and an optical detector. The optic fiber is laid long and disposed in close contact with a target to be measured (e.g., the ground). Laser light emitted from a light source is converted into optical pulses by an optical modulator and transmitted into an optic fiber through an optical circulator. The optical signal travels in a forward direction along the optic fiber, but there is a reflective signal that is reflected backward due to scattering of light at each point consecutive points) along the optic fiber through which light passes. In other words, light propagating through the optic fiber collides with particles smaller than an optical wavelength due to the non-uniformity in optic fiber density, causing scattering and generating a reflected signal (backscattered light) in the opposite direction. The backscattered light returning from the optic fiber is then directed to an optical amplifier through an optical circulator. The optical amplifier amplifies the backscattered light and transmits it to an optical detector, where the backscattered light is converted into an electrical signal. Finally, a digital converter converts the electrical signal (analog signal) into a digital signal. A processing circuit (not shown) processes and analyzes the digital signal.

Backscattered light is generated and returned from all points in the optic fiber, where backscattered light generated at the beginning of the optic fiber arrives first and backscattered light generated at the end thereof arrives last. When the backscattered light returns after one optical pulse transmission is arranged in chronological order, it corresponds to the order in which the backscattered light returns from each point from the beginning to the end of the optic fiber. That is, the arrival time of the backscattered light is ultimately the same as the point (distance) at which the backscattered light occurs in the optic fiber. If an abnormal pattern is observed in a specific part of the signal that is detected consecutively in order of time (or distance), it can be confirmed that an external factor such as vibration or temperature change has acted on the optic fiber at that point.

That is, in a normal state where there is no external action on the target, the reflected signal shows a consistent pattern. However, when an external influence such as vibration act on the target and optic fiber, the scattering size, frequency, and phase of light change, and thus the reflected signal shows a pattern different than in the normal state. By detecting a reflected signal having a pattern different than in the normal state, it is possible to infer that an event has occurred in the target/optic fiber. In addition, since the backscattered light is detected in chronological order as mentioned above, if a normal pattern signal arrives first and then an abnormal pattern signal arrives at a certain point in time, it is possible to determine at which point in the optic fiber this abnormal signal occurred.

As described above, by using the optic fiber sensor, the backscattered light signal that is scattered and returned from all points of the optic fiber can be obtained, and the optic fiber sensor has a spatial resolution in units of at least approximately 0.2 meters, and thus the same effect as installing previous vibration sensors such as geophones or hydrophones at approximately 0.2 meter intervals are achieved.

One of the technical issues with optic fiber sensors is that the signal intensity of backscattered light decreases in proportional to the distance. The graph of FIG. 2 shows the intensity of a signal, which returns from each point after the optical signal is transmitted to an approximately 50 km-long optic fiber sensor, after the signal is amplified by an optical amplifier. For reference, V1, V2, and V3 in the graph represent backscattered light obtained by being modulated into three signals with an approximately 120-degree phase difference using the differential and cross-multiply (DCM) demodulation method. The DCM phase demodulation method is a well-known technology in the industry, and thus a detailed description thereof will be omitted.

Referring to the graph of FIG. 2, it can be seen that the backscattered scattered light returned from points close to the light source have a large signal intensity, but the signals returned from further away have a very small intensity. This is a result of optical loss occurring as the propagation distance of light increases. When the signal intensity is low in this manner, signal processing and analysis using phase demodulation methods become difficult. Therefore, it is necessary to make the intensity of the signal equal overall regardless of the distance at which the backscattered light occurs.

Conventionally, the backscattered light signal is converted into a digital signal by a digital converter (an AD converter), and then a digital signal value is mathematically amplified by multiplying the digital signal value by a distance-dependent multiplier value (loss coefficient of approximately 0.4 db/km). Therefore, backscattered light returned from a long distance is multiplied by a high multiplier and backscattered light returned from a short distance is multiplied by a low multiplier to equalize the intensity of the signal overall.

However, there is a problem that a lot of granular noise occurs during a quantization process of converting the analog signal into the digital signal in the AD converter. The quantization process refers to a process of approximating a sampled analog value to a predetermined digital value. For example, digital values are discrete in units of 1. If an analog signal value is approximately 1.6, the value is converted to an approximate value of 2, and if an analog signal value is approximately 1.4, the value is converted to an approximate value of 1. It is a difference of approximately 0.2 in terms of an analog value, but when the analog signal is converted into a digital signal, a difference of 1 occurs, and thus the analog signal is not accurately reflected. Particularly, granular noise becomes more problematic when quantization is performed with fewer bits and the resolution is low. In optic fiber sensing, backscattered light returning from a long distance is more influenced by quantization errors than when the signal value is large because the intensity of the backscattered signal itself is very small, and the error becomes larger when quantization is performed using fewer bits.

If the digital signal is mathematically amplified as previously dome after granular noise is generated in AD conversion, the noise also increases, which will inevitably reduce the precision and reliability of signal processing and analysis.

### SUMMARY

The present disclosure provides a distributed optic fiber sensor system for equalizing backscattered light capable of amplifying a backscattered light signal so that the signal intensity of backscattered light in an optic fiber sensor becomes equal regardless of the point (distance) where light is scattered and suppressing noise as much as possible.

The present disclosure provides a method for variably amplifying backscattered light returning from an optic fiber sensor according to the distance to the point where backscattered light is generated.

The present disclosure also provides other matters that will be considered within the scope that can be readily inferred from the detailed description and effects thereof below.

In accordance with an exemplary embodiment of the present invention, a distributed optic fiber sensor system includes a light source configured to transmit light, an optic fiber sensor that includes an optic fiber through which light transmitted from the light source propagates, an optical amplifier configured to amplify a backscattered light signal scattered and returned from the optic fiber with a constant gain, a semiconductor optical amplifier (SOA) configured to amplify the backscattered light signal amplified by the optical amplifier, but variably amplify the backscattered light signal by increasing a gain as a point where the backscattered light signal is generated in the optic fiber sensor is farther from the light source, an optical detector configured to convert the backscattered light signal amplified by the semiconductor optical amplifier into an electrical signal, and an AD converter configured to convert the electrical signal from the optical detector into a digital signal.

In accordance with another exemplary embodiment of the present invention, a method for setting a variable gain of backscattered light of an optic fiber sensor is to variably amplify backscattered light generated at each point of an optic fiber and returned therefrom according to a distance from a starting point of the optic fiber to a point where the backscattered light is generated using a semiconductor optical amplifier, the method including determining a minimum gain for the backscattered light, determining a maximum gain for the backscattered light, and determining a control function for a path between the minimum gain and the maximum gain.

In one example of the present disclosure, the minimum gain may be set within a range of 0.5 to 1.5.

In one example of the present disclosure, the maximum gain may be determined by multiplying an optical loss rate according to a distance of the optic fiber by a length of the optic fiber.

In one example of the present disclosure, a sine function may be used as the control function, and an entire period or a predetermined specific section in the sine function may be used.

For example, the control function may be determined by the following equation:

$$G ( dB ) = C \times [ K + SIN \{ ( H \times D ( km ) + {S}^{∘} \} ] + P$$

Here, G is a gain (dB), C is a coefficient for adjusting the maximum gain, P is the minimum gain, D is a distance (km) from a fiber's starting point to a point where backscattered light is generated, K is a coefficient that determines a vertical shift of the sine function, is a value which is equal to a value of SIN{(H×D(km)+S°) at the fiber's starting point (D=0) but with the opposite sign, and is used to adjust the minimum gain to a P value, H is a coefficient that is multiplied by distance D to determine the period of the sine function, S° (angle) is a phase delay value for setting a starting point of the sine function, and a determination may be made on which section of the sine function to use to amplify the backscattered light using H and S.

In one example of the present disclosure, as the control function, the following equation which is an exponential function may be used.

$$G ( dB ) = EXP ( B \times D ( km ) )$$

Here, G is the gain (dB), and B is a coefficient used to adjust the increment of the exponential function, such that the G value becomes the maximum gain when the D value is at its maximum.

### BRIEF DESCRIPTION OF THE DRAWINGS

Exemplary embodiments can be understood in more detail from the following description taken in conjunction with the accompanying drawings, in which:

FIG. 1 is a diagram for describing an optic fiber sensor system;

FIG. 2 is a graph showing signal intensity after performing primary amplification on backscattered light signals returned from each point of an approximately 50 km-long optic fiber sensor by an EDFA;

FIG. 3 is a schematic diagram of a distributed optic fiber sensor system according to an example of the present disclosure;

FIG. 4 is a diagram for describing a semiconductor optical amplifier;

FIG. 5 is a graph illustrating a function for a variable gain;

FIG. 6 is a graph for describing a case where a sine function is used as a variable amplification control function;

FIGS. 7 and 8 are enlarged graphs of the vicinity of approximately 10 km and the vicinity of approximately 40 km of FIG. 2, respectively;

FIG. 9 is a graph illustrating the results of variable amplification of backscattered light according to distance using a semiconductor optical amplifier;

FIGS. 10 and 11 are enlarged graphs of the vicinity of approximately 10 km and the vicinity of approximately 40 km of FIG. 9, respectively;

FIG. 12 is a graph showing differences between the three signal values and the average value in FIG. 10;

FIG. 13 is a graph showing differences between the three signal values and the average value in FIG. 11.

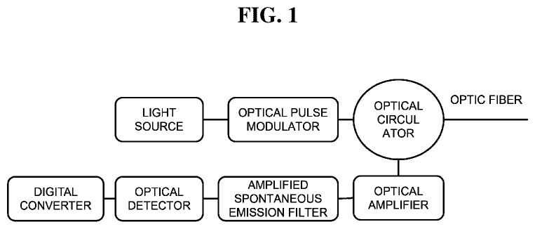

It is to be understood that the accompanying drawings are provided for reference only to help understand the technical idea of the present disclosure, and the scope of the rights of the present disclosure is not limited thereto.

### DETAILED DESCRIPTION OF EMBODIMENTS

In describing the present disclosure, detailed descriptions of related known functions that are obvious to those skilled in the art and may unnecessarily obscure the gist of the present disclosure will be omitted.

Hereinafter, with reference to the accompanying drawings, a distributed optic fiber sensor system according to an example of the present disclosure and a method for setting a control function that varies the gain in the semiconductor optical amplifier of the distributed optic fiber sensor system will be described in more detail.

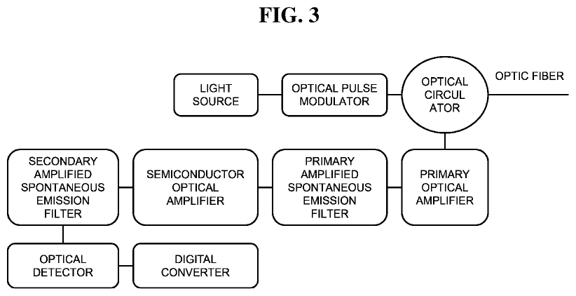

FIG. 3 is a schematic diagram of a distributed optic fiber sensor system according to an example of the present disclosure.

Referring to FIG. 3, the distributed optic fiber sensor system according to an example of the present disclosure includes a light source, an optic fiber sensor, a semiconductor optical amplifier, an optical detector, and an AD converter.

In this embodiment, the light source emits continuous wave (CW) light. To increase measurement sensitivity in an optic fiber sensor system, a laser with a narrow linewidth and good coherence is used. When the intensity of the light emitted from the light source is not sufficient to generate backscattered light in the optic fiber sensor, an erbium-doped fiber amplifier (EDFA) (not shown) is used to amplify the light intensity. In the optical amplifier, spontaneous emission light is generated in a process of amplifying an output wavelength of laser light through stimulated emission, which is called amplified spontaneous emission noise. The light output from the optical amplifier passes through an ASE band-pass filter (not shown) to remove ASE noise.

After being emitted from a light source and having noise removed, the light is modulated into a pulse form by an optical pulse modulator. To improve spatial resolution, it is desirable to modulate the optical pulse into a short form on the order of tens of nanoseconds. However, by using optical pulses with narrow linewidths and short wavelengths, the amount of optical energy transmitted to the optic fiber is reduced, and the intensity of backscattered light is also reduced.

The optical pulses transmitted from the optical pulse modulator are transmitted to the optic fiber sensor through an optical circulator. The optical circulator includes an input port to which light is input, an input/output port for outputting and receiving light to and from the optic fiber sensor, and an output port for transmitting backscattered light generated in the optic fiber sensor to an optical amplifier to be described below.

The optic fiber sensor consists of an optic fiber through which light propagates and a protective cladding that surrounds and protects the optic fiber. As an optical pulse passes through the optic fiber sensor, backscattered light is generated. That is, at each point (consecutive) along the optic fiber through which the optical pulse passes, the non-uniformity of optic fiber density causes the optical pulse to collide with particles smaller than the wavelength of the light to generate the so-called ‘Rayleigh’ scattered backscattered light, and this backscattered light propagates in the opposite direction to the direction in which the optical pulse travels, passes through the optical circulator, and is transmitted to an optical amplifier, which will be described below.

The optical amplifier amplifies the backscattered light signal. Because the backscattered light is too weak to be measured by an optical detector, the light intensity is amplified first. The optical amplifier amplifies all optical signals returning from the optic fiber at a uniform rate. Since EDFA has a reaction rate of several milliseconds, which is very slow compared to the speed of light, detailed variable amplification is impossible. but the gain (amplification rate) is large, and thus it is advantageous to uniformly amplify the signal. In the example, the signal intensity of the backscattered light is at the level of approximately −60 dBm, but it is amplified to the level of approximately −30 dBm (logarithmic scale) through the amplifier, which is approximately 1,000 times amplified. In this example, the EDFA described above is used as the optical amplifier.

An amplified spontaneous emission filter is installed at the rear end of the optical amplifier. The amplified spontaneous emission noise generated by the optical amplifier is removed through the amplified spontaneous emission filter.

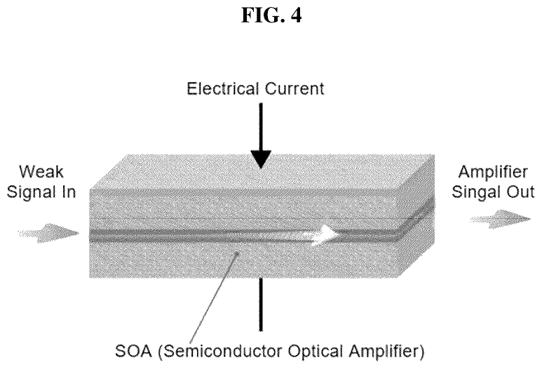

The light filtered by the amplified spontaneous emission filter is transmitted to a semiconductor optical amplifier (SOA). FIG. 4 schematically illustrates the configuration of the semiconductor optical amplifier. Referring to FIG. 4, in the semiconductor optical amplifier, when an optical signal is input through a narrow slit with a width of approximately 1 to 2 μm wide and a length of approximately 0.5 to 2 mm and a current is applied to the semiconductor optical amplifier, a semiconductor material is activated and charged particles are generated. When the generated charges and the optical signal meet, stimulated emission occurs, and as light is generated, the intensity of the optical signal increases. The gain varies depending on the magnitude of the applied current.

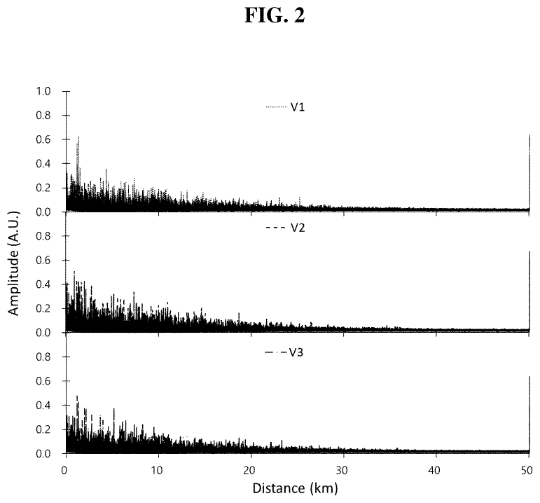

The reason for using the semiconductor optical amplifier in the present disclosure is for variable amplification. As previously described, backscattered light generated close to the light source experiences less optical loss and thus has a higher signal intensity. while backscattered light generated farther away has a lower signal intensity. Although it was amplified once by the EDFA amplifier, at this time, the entire signal was amplified at the same magnification regardless of the point where while backscattered light generated, and thus, as shown in FIG. 2, the intensity of the signal returned from a point far from the light source is still very small compared to the intensity of the backscattered light generated at a close distance. Therefore, variable amplification is required. Variable amplification refers to uniformly adjusting the signal intensity to a constant level at all points by increasing the gain for optical signals scattered farther away from the light source and decreasing the gain for signals scattered from a nearby point. Importantly, it should be possible to quickly change the gain according to the distance (return time).

In an optic fiber, an optical signal travels at a speed that is the speed of light divided by a refractive index of the optic fiber (3×108 m/s÷1.5≈2×108 m/s). Therefore, in the case of an approximately 50 km-long optic fiber, backscattered light begins to flow in immediately from a point in time when light is emitted, and a signal returning from an approximately 50 km point, which is the farthest point, takes about as long as light travel 100 km (approximately 500 μs). That is, once an optical signal is emitted, the backscattered light is received for approximately 500 μs.

Variable amplification requires continuously changing the within the time it takes for the backscattered light to return. The EDFA used in the primary amplification has a control speed for changes in the gain that is only on the order of several milliseconds. That is, it means that the gain cannot be changed within approximately 500 μs. The EDFA has good gain, but its control speed is slow and thus it is impossible to variably amplify extremely high-speed optical signals.

Conventionally, to solve the above problem, as mentioned above, the optical signal was converted to a digital signal, and then the digital signal value was multiplied by a loss coefficient according to distance to mathematically amplify the signal intensity. However, as described above, granular noise occurs in the process of converting the analog signal into the digital signals, and if simple mathematical amplification is performed in the presence of the granular noise, the granular noise also increases, which makes signal processing and analysis difficult.

In contrast, the control speed of the semiconductor optical amplifier used in the present disclosure is extremely fast, at the level of 1 ns. As illustrated in FIG. 4, the gain can be varied by changing the amount of current applied to the semiconductor optical amplifier in units of 1 ns. For example, the gain can be changed approximately 500,000 times in an approximately 500 μs time period, and thus consecutive variable amplification is possible. Semiconductor optical amplifiers have low gain but fast control speeds, which make them suitable for variable amplification of extremely high-speed optical signals. For reference, the semiconductor optical amplifier used in this example performs variable amplification by changing the amount of applied current, as illustrated in FIG. 4. That is, the gain increases as the amount of current increases.

As described above, in the present disclosure, the analog form of backscattered light signal is amplified before granular noise is generated in the AD converter. After amplification, the signal intensity is increased, and thus the granular noise generated during AD conversion does not pose a problem. This is because the granular noise is generated during the quantization process and is very small compared to the magnitude of the signal.

The research team of the present disclosure studied a method for consecutively changing the gain for backscattered light in the semiconductor optical amplifier. Hereinafter, a method for setting a variable gain of backscattered light of the optic fiber sensor according to the present disclosure will be described.

In the method for setting a variable gain of backscattered light according to the present disclosure, the optical loss rate according to distance is specified first for each type of optic fiber. For example, a round-trip optical loss of a certain optic fiber is approximately 0.4 dBm/km. The optical loss rate may vary depending on the optic fiber. Then, the maximum gain is calculated by multiplying the total length of the optic fiber by the optical loss rate. For example, for an approximately 50 km distance, the maximum gain is calculated to be approximately 20 dB.

The minimum gain is also determined. Since the backscattered light returning from the closest distance from the light source (strictly speaking, the entrance of the optic fiber sensor) has the highest signal intensity, this signal can be used as it is or only needs to be slightly amplified. Therefore, the minimum gain is determined to be approximately 1 to 2×. In this example, the signal is used as it is without amplification. That is, a gain of approximately 1× is used.

Accordingly, in this embodiment, a gain of approximately 1× is applied to the backscattered light scattered from the starting point (D=0) of the optic fiber, and a gain of approximately 20× is applied to the backscattered light returning from the farthest point.

In addition, a variable amplification control function for determining how to change the gain according to the distance can be selected in various ways depending on the signal pattern of the backscattered light over distances.

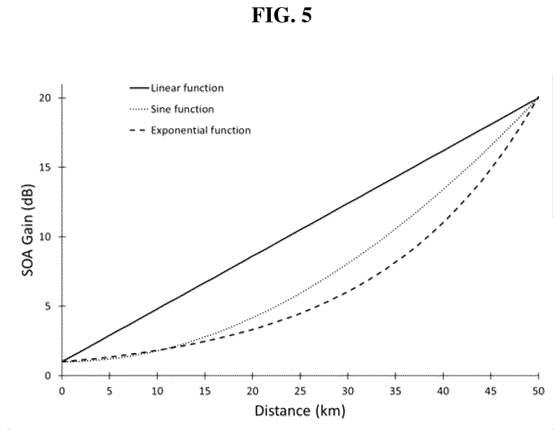

FIG. 5 illustrates cases where the gain is varied in the form of a linear function, a sine function, and an exponential function. In the three control functions, the minimum gain is approximately 1× and the maximum gain is approximately 20×, but the paths where the gain varies differ. How to vary the gain may be determined by examining the signal intensity pattern of the backscattered light subjected to primary amplification. If backscattered light signal subjected to primary amplification shows a linear pattern that changes consistently with distance, a linear function may be used, and if the degree of change varies depending on the distance, an exponential function or a sine function may be used in consideration of the degree of change.

When using a linear function, Equation (1) below is used as the control function for the gain.

$$G ( dB ) = A \times D ( km ) + P \qquad Equation ( l )$$

Here, G represents the gain in dB units, and A represents the slope.

The value of A can be adjusted for each case in consideration of the degree of signal intensity reduction according to the distance of the backscattered light. In this example, a loss coefficient of approximately 0.4 dB/km according to the distance of the optic fiber is used. D is the distance in kilometers from the starting point 0 of the optic fiber to the point where backscattered light occurs. The D value is the same in Equations (2) and (3) below.

As the second term to be added P is used to adjust the minimum gain at the minimum distance (D=0), and in this example, P=1 is used.

When using a linear function, Equation (2) below is used as the control function for the gain.

$$G ( dB ) = EXP ( B \times D ( km ) ) \qquad Equation ( 2 )$$

Here, G represents the gain in dB, and B is a variable for controlling the increment of the function and may be determined in consideration of the signal intensity pattern of the backscattered light. In this example, the maximum gain is set to approximately 20×, and thus the B value is determined to be 0 approximately 0.06. If the gain for the 50 km point is calculated, e^{(0.06×50)}=e³=20.0855. The maximum gain may be adjusted to approximately 20× by truncating the decimal point or by mathematical operation of deleting approximately 0.0855 from all points except for the minimum gain point. Alternatively, approximately 20.0855 may be used as it is. The maximum gain may be precisely adjusted to approximately 20×, but a certain range of excess or deficiency is allowable for approximately 20×. For example, an excess or deficiency of ±1 or so is allowable for the value determined as the maximum gain. Adjusting the maximum gain to a set value means allowing a certain range of excess or deficiency in all Equations (1) to (3).

When using a sine function, Equation (3) below is used as the control function for the gain.

$$G ( dB ) = C \times [ K + SIN \{ ( H \times D ( km ) + {S}^{∘} \} ] + P \qquad Equation ( 3 )$$

Here, G represents the gain in dB, and C is a coefficient for the amplitude of the sine function and used to adjust the maximum gain. K is the vertical shift of the sine function and used to adjust the minimum gain to the value of P at the point where the optic fiber starts (D=0). That is, this is an operation that causes the preceding terms, excluding P, to become approximately 0. Therefore, K is a value that has the same value as SIN{(H×D(km)+S°} but the opposite sign. K varies depending on H and S°. H is a coefficient that determines the period of the sine function by multiplying it by the distance D, and S° (angle) is a phase lag value used to set the starting point of the sine function. That is, it is determined by H and S which section of the sine function is used to amplify.

In this example, Equation (3-1) below is used.

$$G ( dB ) = 65 \times [ 1 + SIN \{ ( 0.9 \times D ( km ) + 27 {0}^{∘} \} ] + 1 \qquad Equation ( 3-1 )$$

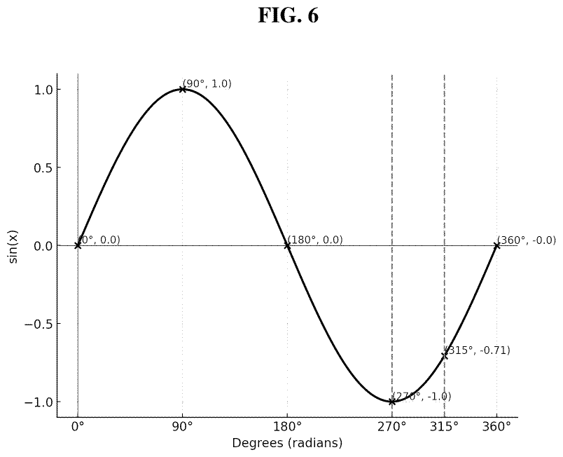

In this example, a section from approximately 270° to 315° in the sine function shown in FIG. 6 is used. Therefore, the phase delay was given using S° as approximately 270°, and the section up to approximately 315° was set based on approximately 50 km which is the farthest point in the optic fiber, with an H value of approximately 0.9. That is, when approximately 0 and approximately 50 are substituted for D, respectively, they become approximately SIN 270° and approximately SIN 315°, respectively. Then, by setting K to approximately 1, the overall value of the function is increased by approximately 1. At approximately SIN 270°, the left term becomes 0 and only the P value (=1) remains, and thus the minimum gain is set to approximately 1 dB. At approximately SIN 315°, the maximum gain is approximately 20.038 dB.

When using the sine function (or cosine function or trigonometric function), each value may be adjusted in Equation (3) above by determining which section of the sine function to use by observing the pattern of backscattered light according to the distance.

In summary, the minimum gain and maximum gain are determined first, the H and S values in the sine function determine the section of the sine function, and the vertical shift value K and amplitude value C are determined to correspond to the preset maximum amplification value. The minimum gain may be adjusted to the P value.

In this example, the section of approximately 270 to 315 degrees is used, but in other examples, a section of approximately 270 to 360 degrees may be used or another section may be used. Since the cosine function is identical to the sine function except for the phase delay, the cosine function can also be used.

In the present disclosure, various functions may be used in addition to the function form mentioned above, and it may also be possible to fit a function for the gain from a backscattered light graph.

Hereinafter, a case where the amplification is performed by the semiconductor optical amplifier according to the present disclosure will be described.

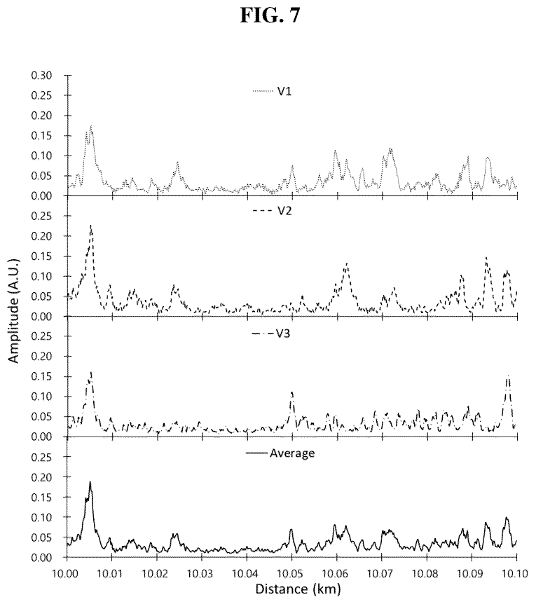

As mentioned previously, FIG. 2 shows the signals obtained by the EDFA performing primary amplification on the backscattered light generated at each point along the approximately 50 km-long optic fiber, and FIG. 7 is an enlarged graph of only the signal near the 10 km point in FIG. 2.

Referring to FIG. 7, V1, V2, and V3 are signals that are divided into three by changing the phase of the backscattered light to approximately 0 degrees, approximately +120 degrees, and approximately −120 degrees using the DCM method, and the average in the last part of the graph is an average value of V1, V2, and V3. In the DCM method, signals are analyzed by using the relative magnitude difference of signals whose phases have been changed at approximately 120-degree intervals. As shown in FIG. 7, since the backscattered light signal at a point as close as approximately 10 km has a large signal strength, a difference value between V1, V2, and V3 may be clearly distinguished.

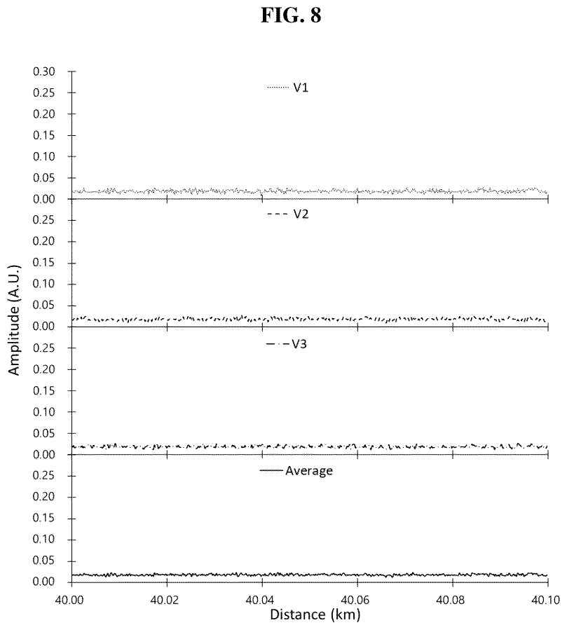

FIG. 8 shows the signals obtained by the EDFA performing primary amplification on the backscattered light generated near the approximately 40 km point in FIG and then splitting it into three signals of V1 to V3. The Y-axis scale is the same as in FIG. 7. Compared to the case of FIG. 7, it is very difficult to distinguish the relative difference between the three signals because the signals are extremely small in magnitude between approximately 0.01 and 0.02 A.U.

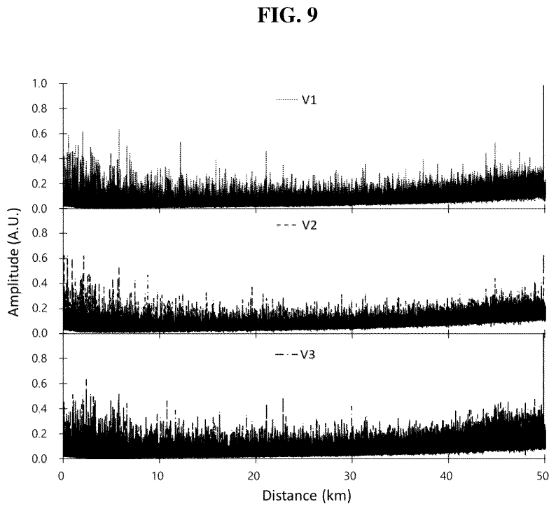

Since it is difficult to analyze the signal of backscattered light occurring at a long distance in the optic fiber if only the primary amplification is performed in this way, secondary variable amplification is used, the backscattered light that is variably amplified using Equation (3-1) described above according to the present disclosure is shown in FIG. 9.

Referring to FIG. 9, it can be seen that, as a result of amplification using the semiconductor optical amplifier, the magnitude of the signal is amplified to a similar level regardless of the generation distance of the backscattered light.

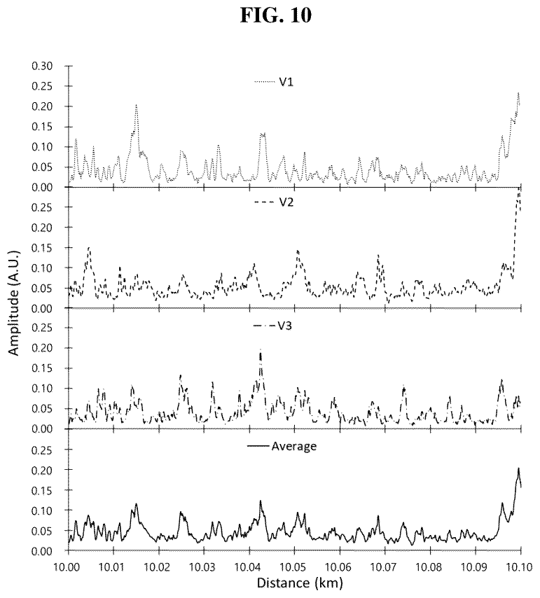

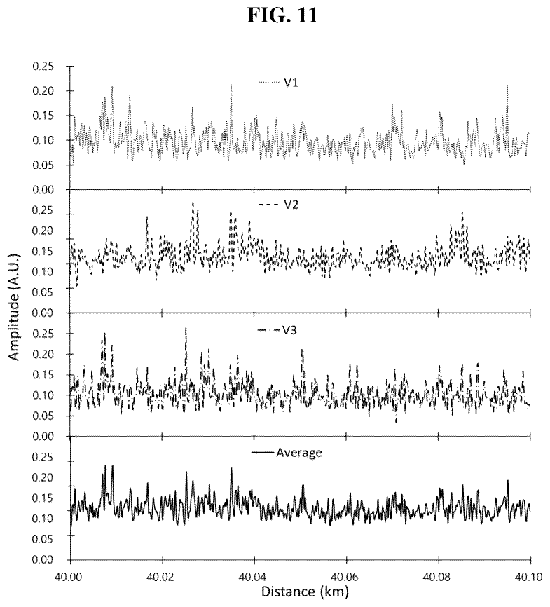

FIG. 10 is an enlarged graph of a 10 km point in FIG. 9, and FIG. 11 is an enlarged graph of of an approximately 40 km point. As shown in FIG. 10, the intensities of the three signals V1 to V3 can be clearly distinguished at a close point of approximately 10 km, and referring to FIG. 11, a relative intensity difference between the three signals at each point can be clearly distinguished even at a long distance of approximately 40 km.

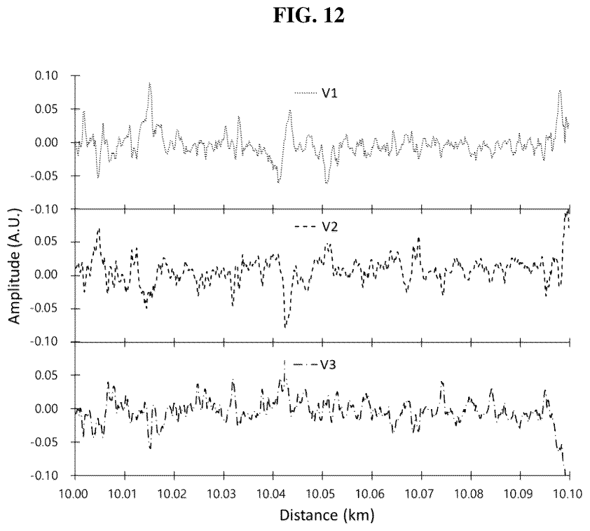

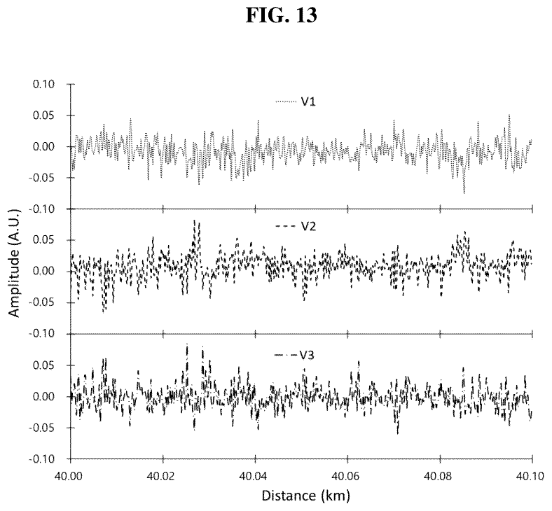

FIG. 12 shows a difference between the three signal values and the average value in FIG. 10. and FIG. 13 shows a difference between the three signal values and the average value in FIG. 11.

Referring to the figures, the intensity difference between three signals at the same point in the vicinity of approximately 10 km which is relatively close distance from the starting point of the optic fiber can be clearly distinguished, and the signal difference even at a distance in the vicinity of approximately 40 km.

As described above, in the DCM method, it is important to split three signals with a phase difference of approximately 120 degrees and then analyze the intensity difference between the three signals. However, when using the semiconductor optical amplifier according to the present disclosure, there is an advantage in that the signal difference can be clearly distinguished even at a long distance point.

In contrast, conventionally, as previously described, the signal subjected to the primary amplification in the EDFA is converted into a digital signal and then mathematical variable amplification is performed on the digital value. Granular noise is generated during the analog-to-digital conversion process, and the influence of granular noise is particularly significant at long distance points where the signal intensity is low. If the mathematical amplification is performed with noise present in this way, signal analysis is difficult because the noise is also amplified.

As described above, the backscattered light that has been variably amplified through the semiconductor optical amplifier is filtered through a secondary amplified spontaneous emission filter. The filtered backscattered light is converted into an electrical signal by the optical detector, and then finally converted into a digital signal through an AD converter (digital converter). The digital signal processed in this manner is used to analyze the signal.

As described above, in the present disclosure, the semiconductor optical amplifier is used to variably amplify a very fast backscattered light signal according to the distance at which the backscattered light is generated. Semiconductor optical amplifiers are suitable for processing optical signals because they enable variable amplification at extremely high speeds.

In addition, the present disclosure can very effectively perform intensity equalization of backscattered light by suggesting a method of setting a variable amplification control function by considering the optical loss rate according to the distance of the optic fiber or by using the signal pattern of the backscattered light.

As described above, in the present disclosure, a very fast backscattered light signal is variably amplified according to a generation distance of backscattered light using a semiconductor optical amplifier. Semiconductor optical amplifiers are suitable for processing optical signals because they enable variable amplification at very high speeds.

In addition, in the present disclosure, intensity equalization of backscattered light can be very effectively performed by suggesting a method of setting a variable gain control function by considering the optical loss rate according to the distance of the optic fiber or by using the signal pattern of backscattered light.

Meanwhile, it should be noted that even effects not explicitly mentioned herein, as well as the effects described in the specification below and their potential effects expected by the technical features of the present disclosure, shall be treated as described in the specification of the present disclosure.

Although the distributed optic fiber sensor system capable of equalizing backscattered light and method for setting the variable gain of backscattered light of optic fiber sensor have been described with reference to the specific embodiments, they are not limited thereto. Therefore, it will be readily understood by those skilled in the art that various modifications and changes can be made thereto without departing from the spirit and scope of the present invention defined by the appended claims.

The scope of protection of the present disclosure is not limited to the description and expression of the embodiments explicitly described above. Furthermore, it should be noted that obvious modifications or substitutions within the technical field to which the present disclosure pertains may not limit the scope of protection of the present disclosure.

What is claimed is:

1. A distributed optic fiber sensor system, comprising:
a light source configured to transmit light;
an optic fiber sensor that includes an optic fiber through which light transmitted from the light source propagates;
an optical amplifier configured to amplify a backscattered light signal scattered and returned from the optic fiber with a constant gain;
a semiconductor optical amplifier (SOA) configured to amplify the backscattered light signal amplified by the optical amplifier, but variably amplify the backscattered light signal by increasing a gain as a point where the backscattered light signal is generated in the optic fiber sensor is farther from the light source;
an optical detector configured to convert the backscattered light signal amplified by the semiconductor optical amplifier into an electrical signal; and
an AD converter configured to convert the electrical signal from the optical detector into a digital signal.

2. A method for setting a variable gain of backscattered light of an optic fiber sensor for variably amplifying backscattered light generated at each point of an optic fiber and returned therefrom according to a distance from a starting point of the optic fiber to a point where the backscattered light is generated using a semiconductor optical amplifier set forth in claim 1, the method comprising:
determining a minimum gain for the backscattered light;
determining a maximum gain for the backscattered light; and
determining a control function for a path between the minimum gain and the maximum gain.

3. The method of claim 2, wherein the minimum gain is set within a range of 0.5 to 1.5.

4. The method of claim 2, wherein the maximum gain is determined by multiplying an optical loss rate according to a distance of the optic fiber by a length of the optic fiber.

5. The method of claim 2, wherein a sine function is used as the control function, and
an entire period or a predetermined specific section in the sine function is used.

6. The method of claim 5, wherein the control function is determined by the following equation,
$$G ( dB ) = C \times [ K + SIN \{ ( H \times D ( km ) + {S}^{∘} \} ] + P$$
where G is a gain (dB), C is a coefficient for adjusting the maximum gain, P is the minimum gain, D is a distance (km) from a fiber's starting point to a point where backscattered light is generated, K is a coefficient that determines a vertical shift of the sine function, is a value which is equal to a value of SIN{(H×D(km)+S°) at the fiber's starting point (D=0) but with the opposite sign, and is used to adjust the minimum gain to a P value, H is a coefficient that is multiplied by distance D to determine the period of the sine function, S° (angle) is a phase delay value for setting a starting point of the sine function, and a determination is made on which section of the sine function to use to amplify the backscattered light using H and S.

7. The method of claim 2, wherein, as the control function, the following equation which is an exponential function is used,
$$G ( dB ) = EXP ( B \times D ( km ) )$$
where, G is the gain (dB), and B is a coefficient used to adjust the increment of the exponential function, such that the G value becomes the maximum gain when the D value is at its maximum.
